(19) United States
(12) Patent Application Publication
(10) Pub. No.: US 2025/0165773 A1
(43) Pub. Date: May 22, 2025

(54) AI BASED SEARCH AND RESCUE TECHNOLOGY PLATFORM

(71) Applicants: Martha Grabowski, Cazenovia, NY (US); Gwendolyn Morgan, Brewerton, NY (US); Jean-Philippe Rancy, Queens Village, NY (US); James McGarvey, Syracuse, NY (US)

(72) Inventors: Martha Grabowski, Cazenovia, NY (US); Gwendolyn Morgan, Brewerton, NY (US); Jean-Philippe Rancy, Queens Village, NY (US); James McGarvey, Syracuse, NY (US)

(21) Appl. No.: 18/515,909

(22) Filed: Nov. 21, 2023

(51) Int. Cl. G06N 3/08

(52) U.S. Cl. CPC G06N 3/08

(57) ABSTRACT

A search and rescue (SAR) application platform configured to provide SAR support services. A process includes: receiving, at a mission support system, mission data from structured and unstructured data feeds including data from an unmanned aerial system (UAS); outputting mission support information to a set of output nodes having disparate user interfaces (UIs), wherein at least one of the output nodes includes an augmented reality (AR) equipped device; and receiving, at a large language model (LLM), queries from the mission support system, and generating AI responses that augment the mission support information, wherein the LLM is trained with a model training system using structured and unstructured data sources involving SAR content.

### TECHNICAL FIELD

The present invention relates to decision support for emergency and disaster response operations, and more particularly to a technology platform for training and deploying a specialized generative artificial intelligence (AI) model to enhance decision support technologies, such as search and rescue (SAR) platforms.

### BACKGROUND

Decision support for users engaged in safety-critical operations such as Arctic search and rescue (SAR), oil spill responses, etc., requires obtaining and processing real-time information from a variety of modes or channels. Such multimodal decision support systems may for example receive information from system and sensor monitoring; mission, operation, target and survivor status; search and rescue planning and coordination; etc. Operators in such settings must make crucial decisions in real-time, utilizing relevant information to monitor, assess and respond to critical incidents.

### SUMMARY

In one aspect, a search and rescue (SAR) application platform is provided that includes: a memory and a processor configured to provide SAR support services according to a process that includes: receiving, at a mission support system, mission data from structured and unstructured data feeds including data from an unmanned aerial system (UAS); outputting mission support information to a set of output nodes having disparate user interfaces (UIs), wherein at least one of the output nodes includes an augmented reality (AR) equipped device; and receiving, at a large language model (LLM), queries from the mission support system, and generating AI responses that augment the mission support information, wherein the LLM is trained with a model training system using structured and unstructured data sources involving SAR content.

In a further aspect, a method for providing search and rescue (SAR) support services is disclosed, comprising: receiving, at a mission support system, mission data from structured and unstructured data feeds including data from an unmanned aerial system (UAS); outputting mission support information to a set of output nodes having disparate user interfaces (UIs), wherein at least one of the output nodes includes an augmented reality (AR) equipped device; and receiving, at a generative artificial intelligence (AI) model, queries from the mission support system, and generating AI responses that augment the mission support information, wherein the generative AI model is trained using structured and unstructured data sources involving SAR content.

In another aspect, emergency and disaster response (EDR) application platform is disclosed, comprising: a memory and a processor configured to provide EDR support services according to a process that includes: receiving, at a mission support system, mission data from structured and unstructured data feeds including data from an unmanned aerial system (UAS); outputting mission support information to a set of output nodes having disparate user interfaces (UIs), wherein at least one of the output nodes includes an augmented reality (AR) equipped device; and receiving, at a large language model (LLM), queries from the mission support system, and generating AI responses that augment the mission support information, wherein the LLM is trained with a model training system using structured and unstructured data sources involving EDR content.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative search and rescue technology platform, in accordance with an illustrative embodiment.

FIG. 2 depicts a mission support system, in accordance with an illustrative embodiment.

FIG. 3 depicts a wearable device in the form of smart glasses with the left lens active, in accordance with an illustrative embodiment.

FIG. 4 depicts a wearable device in the form of smart glasses with the right lens active, in accordance with an illustrative embodiment.

FIG. 5 depicts an emergency and disaster response development infrastructure, in accordance with an illustrative embodiment.

FIG. 6 depicts a network infrastructure, in accordance with an illustrative embodiment.

FIG. 7 depicts a computing system, in accordance with an illustrative embodiment.

The drawings are intended to depict only typical aspects of the disclosure, and therefore should not be considered as limiting the scope of the disclosure.

### DETAILED DESCRIPTION

Emergency and disaster response (EDR) efforts are particularly challenging in remote and underserved areas, in which first responders and other personnel have limited resources and infrastructure required to carry out operations. For instance, the lack of a reliable communication infrastructure can limit the ability to provide timely information to personnel responding, which is critical for successful and efficient outcomes. While there exist any number of technology platforms that can support EDR efforts, e.g., uncrewed aerial systems (AES), global positioning systems (GPS), augmented reality (AR) devices, satellite communications, etc., the type and amount of information required can greatly vary depending on, e.g., the person assisting in the operation, type of mission, existing threats (e.g., violent storms, coastal erosion/subsidence, landslides, winter conditions, earthquakes, tsunamis, floods), etc. Furthermore, critical knowledge important to a mission oftentimes is not readily available in any structured format that allows for easy access, e.g., relevant geographies such as available trails and paths, river flow characteristics, survival assets, wildlife sounds, localized weather behavior patterns, etc. In many cases, such knowledge may be held only by local residents, recorded in oral narratives, drawings, journals, podcasts, articles, etc.

To address such challenges, an artificial intelligence (AI) based technology platform is disclosed that provides flexible and collaborative decision support for emergency and disaster response efforts. In certain aspects, the disclosed platform utilizes a specialized large language model (LLM) to enhance decision support to the personnel and systems involved. As noted, existing technology platforms for providing decision support are known, and are for example described in U.S. Pat. No. 11,361,664, issued on Jun. 14, 2022, entitled INTEGRATION OF UNMANNED AERIAL SYSTEM DATA WITH STRUCTURED AND UNSTRUCTURED INFORMATION FOR DECISION SUPPORT; and U.S. patent application Ser. No. 18/051,161, filed on Oct. 31, 2022, entitled MULTIMODAL DECISION SUPPORT SYSTEM USING AUGMENTED REALITY, the contents of each are hereby incorporated by reference. In certain aspects, the present disclosure enhances these technology platforms, as well as others, by utilizing a large language model and other AI tools to provide a more flexible decision support platform.

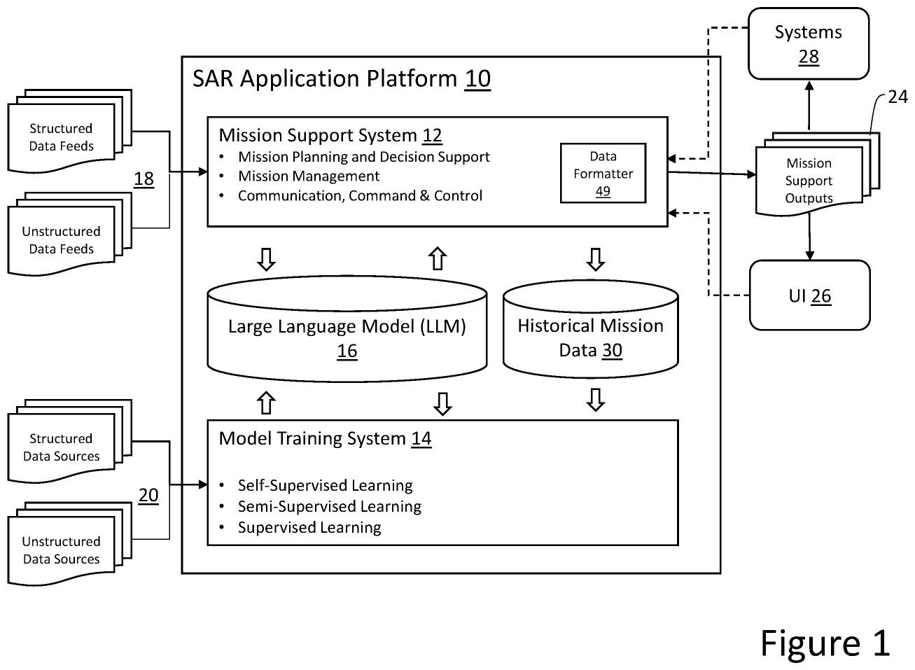

FIG. 1 depicts an illustrative emergency and disaster response (EDR) application platform, in this case a search and rescue (SAR) application platform 10 that includes a specially trained LLM 16 to provide enhanced decision support for SAR missions. Central to platform 10 is a mission support system 12 that provides mission planning and decision support, mission management, and communication, command and control (CCC) services. In an illustrative embodiment, during a SAR mission, mission support system 12 receives mission data 18 from structured and unstructured data feeds and generates mission support outputs 24 to user interfaces (UIs) 26 and other systems 28. Mission support outputs 24 may for example be generated, facilitated, augmented, optimized, etc., in response to queries made to LLM 16.

For example, mission support system 12 could receive mission data 18 for a SAR mission involving a group of stranded hikers, in which mission data 18 includes a mission type, a weather report, GPS coordinates, a list of active emergency responders and their roles, time data, natural language inputs such as texts and speech, available UAS and AR resources, etc. Once received, mission data 18 can be structured into a query that is fed into LLM 16 to enhance decision support efforts. For example, when a mission begins an initial mission data 18 is received, a query could be generated that states: “Generate a mission plan for a set of n personnel have roles a, b, c . . . , with SAR resources x, y, z, for stranded hikers last seen at p, q coordinates at 12 pm.” In this case, the mission support output 24 would comprise an initial SAR plan having, e.g., instructions for a drone, meeting locations for different groups of personnel, communication protocols to be used, assigned tasks for personnel, etc. Depending on the role of the personnel involved and their type of UI 26 (e.g., smartphone, AR system, etc.), different types of mission support outputs 24 may be generated by data formatter 49 and presented to different personnel. As the mission advances, mission support system 12 may submit new queries (either automatically or in response to newly collected data or a user request) and new mission support outputs 24 may be generated.

LLM 16 may for example be implemented based on an existing foundational LLM (e.g., ChatGPT, etc.) that is further trained by model training system 14 using training data 20. Training data 20 may for example comprise structured and unstructured data sources tailored to search and rescue operations. Additionally, LLM 16 may be trained using historical mission data 30 that is collected after each mission. Furthermore, LLM 16 may be trained using any technique, e.g., supervised learning, self-supervised learning, semi-supervised learning, etc. Additionally, although not shown, LLM 16 may be part of a larger AI infrastructure that can include other types of generative AI (e.g., an image generator), deep learning models or neural networks (e.g., that predict mission outcomes), etc.

Structured training data may for example include environment data, communication data, inventory data and logistic data. Examples include: (1) thermal, geospatial, environmental, temperature/humidity/dew point and weather data; (2) communication data from satellite and other geospatial systems; (3) communication data from response organizations; command and control organizations; resource management and protection agencies; federal, state, borough and local regulatory entities; local stakeholders; and public affairs organizations; (4) external environmental and weather data, (5) resource inventory (personnel, capital equipment, finance) data and (6) logistics (schedule, delays, shipping and storage node, etc.) information.

Unstructured training data may for example include (1) geological data (images and/or text), e.g., charts, images, blueprints, terrestrial and elevation models and maps; ice and geological formation data and trends; inland and oceanic water and ice flow data; sand, gravel and geological baseline and trend data and images; tsunamigenic landslide images, projections and trends; (2) scientific data, e.g., images, visualizations, projections, drawings, pdfs, pictures, and diagrams from traditional and scientific sources of weather forces, effects, trends and conditions; (3) audio data, e.g., oral narratives; podcasts; wildlife signals, sounds and recordings; ceremonial and informal ritual sounds, messages, signals and recordings; (4) haptic data, e.g., data indicating strength, direction, tension, flow and trends for static and dynamic resources; (5) sensor data, e.g., images, sounds, text, smells, and haptic data from real-time sensors; and (6) social media data including, e.g., images, sounds, text, smells, and haptic data from social media sources.

Further, algorithmic output from external processing systems may link, combine, aggregate, analyze, visualize, display, deduce, infer and produce derivative unstructured data and products that can further train LLM 16.

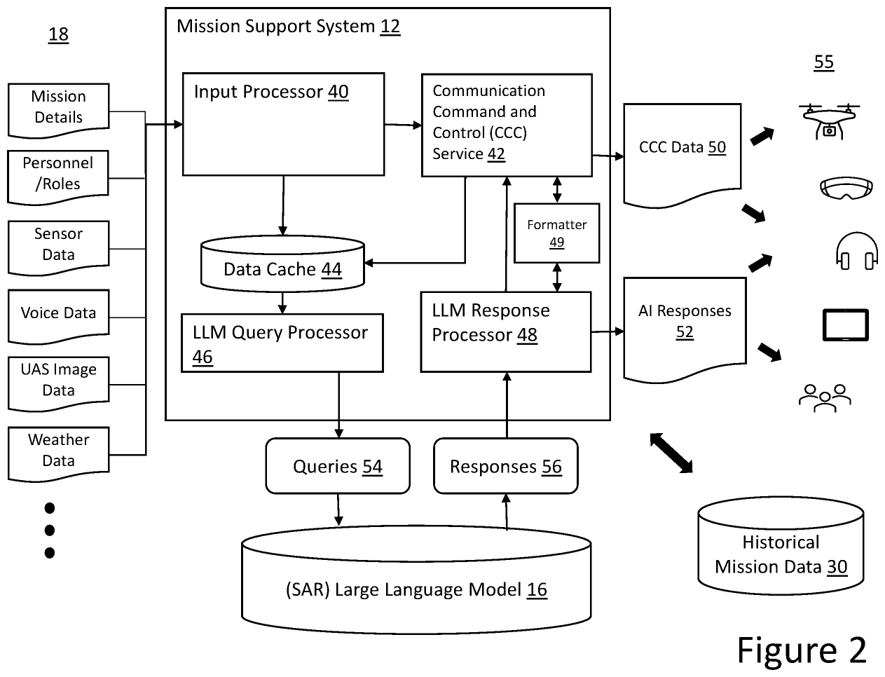

Referring to FIG. 2, an illustrative implementation of mission support system 12 is described in further detail. In this embodiment, mission support system 12 includes an input processor 40 that receives and processes mission data 18 from any number of sources. Mission data 18 may for example include mission details entered by a team leader, support personnel and their roles, sensor data, e.g., from UAS devices, AR devices, etc., voice data, image data, weather data, etc. As noted above, mission data 18 may comprise structured and unstructured information.

Structured information may for example include: (1) thermal, geospatial, environmental, temperature/humidity/dew point and weather data; (2) communication data from satellite and other geospatial systems; (3) communication data from response organizations; command and control organizations; resource management and protection agencies; federal, state, borough and local regulatory entities; local stakeholders; and public affairs organizations; (4) external environmental and weather data, (5) resource inventory (personnel, capital equipment, finance) data and (6) logistics (schedule, delays, shipping and storage node, etc.) information.

Unstructured information may for example include: (1) charts, images, blueprints, terrestrial and elevation models and maps; ice and geological formation data and trends; inland and oceanic water and ice flow data; sand, gravel and geological baseline and trend data and images; tsunamigenic landslide images, projections and trends; (2) images, visualizations, projections, drawings, pdfs, pictures, and diagrams from traditional and scientific sources of weather forces, effects, trends and conditions; (3) oral narratives; podcasts; wildlife signals, sounds and recordings; ceremonial and informal ritual sounds, messages, signals and recordings; (4) haptic data indicating strength, direction, tension, flow and trends for static and dynamic resources; (5) images, sounds, text, smells, and haptic data from real-time sensors; and (6) images, sounds, text, smells, and haptic data from social media.

As data is collected by input processor 40, some or all of the data may be stored in a data cache 44 for LLM processing. Additionally, some or all of the data may be immediately provided to communication, command and control (CCC) service 42 that processes and forwards CCC data 50 to any number of output nodes 55 (e.g., UAS systems, AR systems, audio systems, smart devices, teams of devices, etc.). CCC data 50 may for example comprise UAS instructions, text messages, audio, video, weather data, etc. In certain cases, two or more of the output nodes 55 include disparate UIs, e.g., a mobile App, an AR display, etc. For example, upon receipt by input processor 40, an updated weather report may be immediately forwarded to smart phone apps used by first responders, UAS commands may be immediately forwarded to a UAS device, etc.

In addition, mission support system 12 includes an LLM query processor 46 that processes data captured in data cache 44 and generates queries 54 for LLM 16. Queries 54 may be issued in any manner, e.g., in response to a request from a user, automatically based on information collected in data cache 44, periodically, etc. In certain applications, LLM query processor 46 may include an AI system capable of automatically generating queries 54 based on data received into data cache 44 with or without prompting.

Responses 56 generated by LLM 16 are fed to LLM response processor 48 that processes responses 56, e.g., analyzing responses 56 for accuracy, what output format(s) to use, output nodes 55 that should receive the response 56, editing of responses 56, etc., and formats responses 56 for disparate UIs (including uniquely configured UIs) using data formatter 49. Some responses 56 may be fed to CCC service 42 to augment CCC data 50. For example, the query “are there any survival huts in the region” might generate the response “there are 5 known huts within 2 miles of the hikers last known location at the following coordinates . . . ” These coordinates may for example be utilized by CCC service 42 to automatically alter UAS search parameters generated by CCC service 42. In other instances, responses 56 can be output directly as AI responses 52 (including, e.g., mission planning, mission support details, recommendations, updates, etc.), e.g., broadcast as text messages smart devices of first responders, displayed as images on AR devices, etc.

Incoming mission data 18 may accordingly be used by LLM 16 to evaluate threats, assess SAR choices and alternatives, decide on prioritized courses of action that support a successful mission, etc. Users, via UIs, can not only receive information by can also submit or respond with data to mission support system 12, e.g., input mission details, tactics, available resources, plan and timing priorities and have outputs customized for individual use during a mission or training. As the mission unfolds, historical mission data 30 is collected and processed for LLM training and out purposes. Historical mission data 30 may for example include libraries of draft and final information repositories; be utilized for scenarios, what-if analyses, simulations, and algorithms; analyses can be stored, managed and analyzed to extract trend, leadership development and lessons learned insights. Tactical and strategic plans in the forms of procedures, checklists, resource inventories, dynamic communications and messages that reflect lessons learned in the mission to date and real-time mission status and prognosis, may also constitute the outputted historical mission data 30.

LLM 16 may comprise one or more generative AI models equipped for processing text, images and sound data identify, e.g., potential SAR routes, policies and safe paths; victim and survivor locations; areas at risk; and current weather, environmental, risk and communication data, as well as an assessment of likelihood of successful mission completion. This analysis empowers responders with insights, enabling them to navigate challenging terrain, prioritize areas of need, coordinate with other teams, and optimize resource allocation for a more effective and adaptive emergency response.

The generative AI models may be further equipped to process static and dynamic, real-time and archival image, text, sound and trend data for initial and emerging assessments that reflect real-time data input, prioritized and time-bounded prompts, and required output formats and forecasts. Lessons learned can be automatically developed from the text, sound, image and trend corpus, with real-time assessments of corpus and response changes, trends and recommendations. Opinions, advice, recommendations, assessments and guidance developed by the generative AI models may be previewed by a human analyst and stored in the historical mission data 30 to facilitate automated trend analyses over time. Data communication interruptions, losses or cases of unreliability may be captured, processed and analyzed automatically, with the results automatically routed to the designated SAR individuals, roles and repositories.

In certain embodiments, one or more users can choose the output information to be displayed via a UAS and the format for the display (e.g., on a laptop or AR device). Display settings can be customized by user and role and can be linked to primary and secondary enterprise storage and real-time satellite communications. System 12 is accordingly capable of displaying real-time, archival, trend, analytics and AI-generated recommendations, images and assessments at the level specified by the user during user initialization.

In various approaches, the UI of a given output node 55 displays a mix of real-time, archival, algorithmic, processed and forecast information supporting a successful SAR mission. Real-time information from National Weather Service (NWS) reports, images and trends; amateur radio reports; local and remote communications; satellite information, data, images, sound and analysis; social media data, images and sound; radar; LIDAR, including video; sea, ice, gravel and geological data, images, trends, sounds, and Automated Identification System (AIS) and other real-time data, images, text, trends and sounds can be shown on each UI of an output node 55. Users can prioritize and develop customized displays that reflect user needs, universal access and design principles and human factors engineering principles and guidelines. Technology, system, network, communication and algorithmic redundancy may for example be accessed by icons that activate back up and redundant system and network capabilities in the event of an interruption.

It is understood that different users have different needs during emergency and disaster operations, and system 12 can be configured to provide different levels of information to different users. For example, federal or national government users may require both local and remote access to mission support system 12, depending on their role, location and responsibilities during the SAR mission. Sample data available for federal partners and users includes may include port traffic information, real-time video of the unfolding response as well as a drone's perspective. Areas to be avoided (ATBAs) and sensitive environmental and cultural areas, settings, paths and considerations would be highlighted, with links to relevant national and international regulations, requirements, timing, and data, information and reporting requirements. Geofences illustrating response locations, critical resources, and culturally significant entities and information, would be displayed, along with vessel traffic information and impacts on communities, cyberattacks, tsunamis, earthquakes, floods, and violent storms.

State government users may for example require access to structured and unstructured static and dynamic information similar to that of the federal entities, as well as additional information about port traffic, municipal services, hospital conditions, medical facilities, vessel traffic impacts on communities, tsunamis, earthquakes, floods, and violent storms.

First responders, local community members, volunteers and stakeholders may require access to information such as images, data, trends and algorithmic recommendations based on their role(s) and responsibilities in the mission. Examples of such data may include weather reports, ice conditions, utility conditions, data on climate for snow road, police emergency information, permafrost melt conditions, coastline erosion, vessel traffic, tsunamis, earthquakes, floods, and violent storms.

The public at large may for example be given access to system information released and approved by a Public Affairs Office (PAO) in charge during an event or simulation. In such cases, data released may be coordinated through the PAO and an Incident Command Center.

Furthermore, in certain embodiment, the information, data, trends, recommendations, observations and work provided by mission support system 12 follow Universal Design (UD) principles promoting accessibility by differently-abled persons, independent of role or responsibility during the SAR evolution.

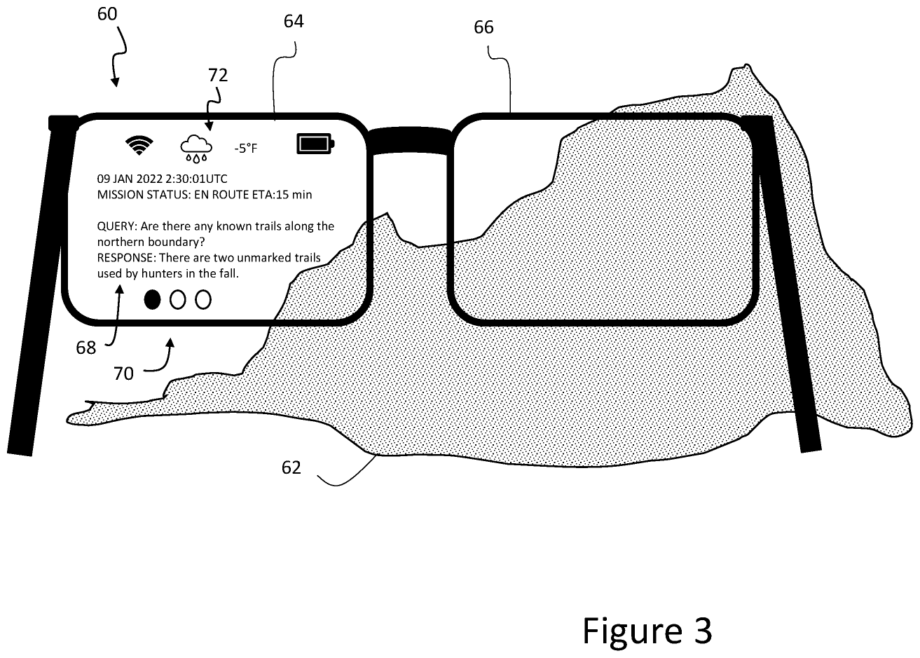

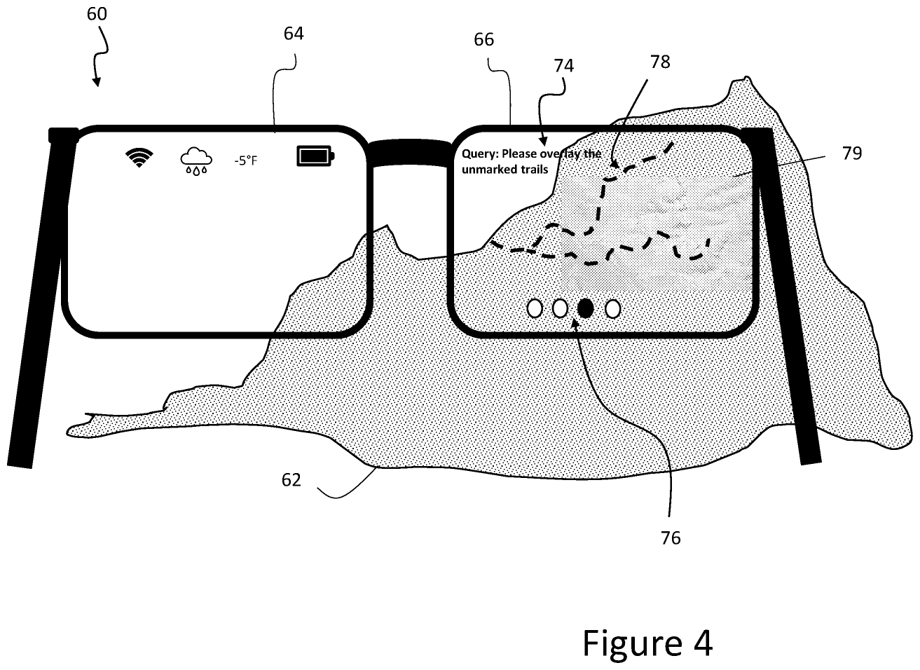

FIGS. 3 and 4 depict an illustrative implementation of a UI system with multimodal interfaces, in this case smart glasses 60, that integrate UAS, AR and LLM within a search and rescue application platform 10. In this example, AR overlays are provided in the smart glasses 60 viewing a terrain feature 62 (e.g., a mountain, lake, land area, etc.). FIG. 3 depicts an example with the left lens 64 activated, i.e., lens 64 includes an overlay showing a page of text-based data, and the right lens 66 is inactive, i.e., lens 66 includes no overlay. Two additional pages are indicated as available by indicators 70, which for example can be accessed with a swipe motion by the user. In this example, the left lens 64 also includes a set of status icons 72 indicating Wi-Fi strength, weather, temperature, and battery status. The displayed data comprises textual mission support outputs 68 generated from mission support system 12 (FIG. 1). Part of mission support outputs 68 include an LLM interaction 68 in which the user submitted a query (e.g., via a microphone and voice to text natural language system), “Are there any known trails along the northern boundary.” The response, generated by LLM 16, is likewise shown, “There are two unmarked trails used by hunters in the fall.”

FIG. 4 depicts an example with the right lens 66 activated, i.e., lens 66 includes an overlay showing image-based data, and the left lens 64 is inactive, i.e., lens 64 includes no overlay data except for the status icons. In this example, UAS generated image data 79 of the landscape is displayed in lens 66 along with an AI generated image 78 of unmarked trails. The AI generated image 78 may for example be generated based on notes, maps, photos or other non-structured information used to train LLM 16. Other AI generated data could likewise be displayed along with the UAS image data 79 by submitting requests or queries to the LLM system. Additionally, other pages 76 of graphical images, e.g., satellite weather data, thermal imaging, LiDAR, etc., could be presented on lens 66 with, e.g., a swipe action by the user. This embodiment also includes an area 74 for displaying queries, voice-to-text messages, audio messages from other team members, etc., in response to the user query/request.

In the illustrative embodiments in FIGS. 3 and 4, the first lens 64 is exclusively configured for displaying text-based data and the second lens 66 is exclusively configured for displaying image-based data. Based on experiments, this AR configuration has been shown to be a highly effective approach for relaying multimodal data to a user in high stress, safety-critical environments. However, it is understood that other AR devices and/or configurations could likewise be utilized.

In one example involving the use of AR enabled smart glasses 60, at the beginning of a mission, an Operations Response leader requests and then downloads mission information from mission support system 12 (FIG. 1) and selects the UI and AR information to be displayed, as well as redundant audio and text information to be provided. For example, the information might include a live video feed with AR overlays showing targets, victims, destinations and supply points integrated from multimodal sources, e.g., a UAS, LIDAR, and radar, with team members' communication audio displayed as text across the UI.

Integrating such elements into the AR enable glasses 60 UI for example involves pulling live audio and video from the mission support system 12, with interaction capabilities provided by microgestures, haptic interfaces, eye tracking and voice, etc. The multimodal interfaces may provide redundancy in displaying conversations visually, and interfaces for those with hearing impairment and other interface challenges. Multiple-way audio between team members, the victim (e.g., using audio from the UAS), and the UAS pilot can improve response as well as provide social support, and text may be displayed in directionally different attitudes. Multimodal interfaces for LLM queries about best practices, migration and wildlife patterns, and learned local knowledge are designed to utilize voice, microgestures, eye tracking and haptic interactions to provide interface and interaction redundancy.

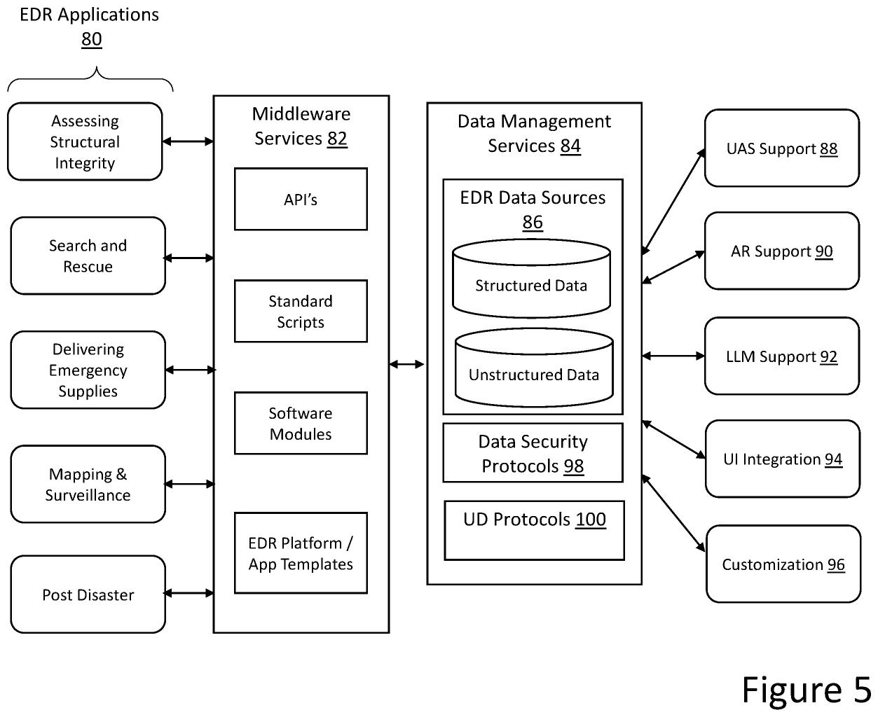

FIG. 5 depicts a uniform EDR application development infrastructure that allows for the development and implementation of different EDR applications 80 (such as SAR application platform 10) using a standardized architecture that leverages and provides data integrations of UAS, AR and LLM resources. In this embodiment, a set of middleware services 82 are provided, including: Application Programming Interfaces (API's) to provide standardized system access for EDR applications 80, standard scripts for configuring data and CCC operations, software modules to perform advanced data processing operations, and a set of EDR platform and App templates that are pre-developed for different EDR domains. The EDR applications may for example comprise structural integrity assessment, search and rescue, emergency supply delivery, mapping and surveillance, and post disaster relief.

The middleware services 82 provide access to backend data management services 84 that can process structured and unstructured data inputted from EDR data sources 86 (e.g., collected before, during, or after a mission). The data management services 84 provide UAS support 88 and AR support 90 to receive, send and display mission data. Additionally, data management services 84 provides LLM support 92, including the ability to create and submit queries, receive and process responses, and provide LLM training. UI integration 94 is provided to allow UI's for different systems (e.g., AR systems, smartphones, laptops, etc.) and roles (team leaders, drone operators, first responders, communication operators, etc.) to be set up such that the appropriate data is provided in the appropriate format to different personnel involved in a mission. Customization 96 provides a mechanism in which a system administrator and/or support personnel can assign roles, determine data formats, deploy assets, etc. The described EDR infrastructure accordingly allows for multiway communication among victims, responders and command center personnel, gives access to voice-enabled UASs, AR systems and LLM interfaces.

Embedded in data management services 84 are data security protocols 98 configured to keep mission data secure.

The described infrastructure increases efficiencies for EDR developers and authorized users and provides standard and defensible security and control interfaces. Furthermore, standardized EDR architectures and interfaces provide common and expected interactions across EDR applications, a development of particular benefit for users with physical and other challenges.

As noted, EDR data sources 86 may include a myriad of structured (e.g., text, sensor data, currency, etc.) and unstructured (e.g., audio, video, animation, simulations, reports, documents, images, etc.) data. Data and application management and data security for personnel, location, event, and trend data over time are important for these data sources. Emergency response supply, geographic information systems, aerial and nautical charting, as well as environmental and weather data, and local data sources, are critical to effective EDR, as is local knowledge of travel paths, wildlife and human migration patterns and seasonal weather trends that impact logistics and supply delivery. Pre- and post-disaster structural integrity assessment requires baseline and seasonal information about infrastructure, buildings, inspections, and safety history over time; assessing structural integrity also requires data and models for assessing structural health in real-time and longitudinally. Post-disaster information about housing, berthing, sanitary, food and personnel security information is paramount in caring for impacted communities. Standard interfaces for each of these data sources can provide links to critical resources and data in EDR applications, improving access for users, developers, EDR managers and the impacted public.

Standard UIs for EDR technology applications require integrating technology interfaces such as those with UAS, AR and LLM, with the wide array of EDR data sources 86 to support the EDR domain requirements. In an illustrative approach, universal design (UD) principles are utilized by implementing UD protocols 100. Standardized UI and multimodal interface options with such protocols can increase UI flexibility and accessibility for authorized users as well as for the impacted public.

UD protocols 100 encourage flexible and customizable UIs for providing emergency and disaster personnel with essential information for all devices (e.g., smartphone Apps, AR systems, etc.). UD protocols 100 ensure users have uniform interaction options and flexibility in configuring and changing the size, position and location of objects referenced, discussed or displayed, supporting users' varying UI requirements. For example, UD protocols 100 may require that audio is displayed as text on screen when team members are communicating with each other, and gesture and microgesture options coupled with voice commands and eye tracking provide interface options for UI configuration. Mission support flexibility allows the UI to be configured in a uniform manner for use by all members of the EDR team, a key UD requirement for EDR technologies.

UD protocols 100 require that users with different abilities should be able to interpret UI information easily, regardless of their cognitive or visual impairments. The protocols 100 provide customizable options for object size, color contrast, and font size that can cater to individual needs, allowing users to understand and navigate the integrated UI. Also, by leveraging LLM support 92, user preferences, use patterns and experience with the UI and system can be learned over time. This could produce adaptive and evolutionary UIs incorporating users' preferred gestures and motions, as well as prioritized vocal, eye tracking and switch control commands. Integrated LLM support 92 can also enhance accessibility by converting audio communication into conversational text, enabling users with hearing and other impairments to participate fully in team communication.

While storage, retrieval and real-time access of LLMs and the data sets on which they rely can be challenging in remote locations with sparse connectivity and limited technology infrastructure, some of these challenges are being addressed with connected swarms of EDR UAS's and with public-private cooperative networks.

AI, including machine learning models, described herein may for example be implemented in software, hardware, or a combination thereof. In certain instances, the AI described herein may include generative AI systems such as large language models (LLMs), which are capable of generating human like responses, images, voices, sounds, etc., in response to inputted natural language queries and the like. Generative AI's may for example include autoregressive language models that repeatedly predict the next token or word based on an input.

Machine learning models (including LLMs) described herein may also include a deep neural network (DNN), which is a type of artificial neural network that is composed of multiple layers of interconnected nodes or artificial neurons. A DNN may for example include a convolution neural network (CNN) designed to work with multi-dimensional grid-like or layered data (e.g., spectrograms, geographic data, weather data, etc.), recurrent neural networks (RNNs) or variants like Long Short-Term Memory (LSTM), which can be combined with CNNs.

DNNs generally include an Input Layer that receives the raw data or features. Each neuron in this layer corresponds to an input feature. For example, in image recognition, each neuron might represent a pixel's intensity value. DNNs further include a Weighted Sum and Activation Function in which each connection between neurons in adjacent layers has an associated weight. The input data is multiplied by these weights, and the results are summed up for each neuron in the next layer. An activation function is applied to this weighted sum to introduce non-linearity and make the network capable of learning complex relationships. Common activation functions include ReLU (Rectified Linear Unit), Sigmoid, and Tanh. Between the input and output layers there can be one or more Hidden Layers. These layers contain neurons that learn progressively more abstract and complex features from the input data. Each neuron in a hidden layer receives inputs from all neurons in the previous layer, applies the weighted sum and activation function, and passes the result to the next layer. The last layer in the DNN is the Output Layer, which produces the final result of the network's computation. The number of neurons in the output layer depends on the specific task. For instance, in binary classification, there might be one neuron for each class, whereas in multi-class classification, there may be one neuron per class.

The DNN is trained for example using supervised learning, e.g., by repeatedly presenting training data to the network, calculating the loss, and updating the weights using backpropagation and optimization algorithms. This process continues until the model converges to a satisfactory level of performance. The process may include use of a loss function that measures the difference between the predicted output and the actual target. Common loss functions include mean squared error for regression tasks and categorical cross-entropy for classification tasks. Optimization algorithms adjust the weights in the network to minimize the loss function iteratively. Gradient descent, stochastic gradient descent (SGD), and Adam, may for example be utilized.

Training for supervised learning may utilize a dataset that includes input data (features) and corresponding target outputs (labels). Once trained, the DNN can be used for inference on new, unseen data. The input data is passed through the network, and the output provides predictions or classifications based on what the network has learned during training. The DNN may be periodically evaluated on a separate validation dataset to monitor how well it generalizes to unseen data. This helps prevent overfitting, where the model becomes too specialized on the training data.

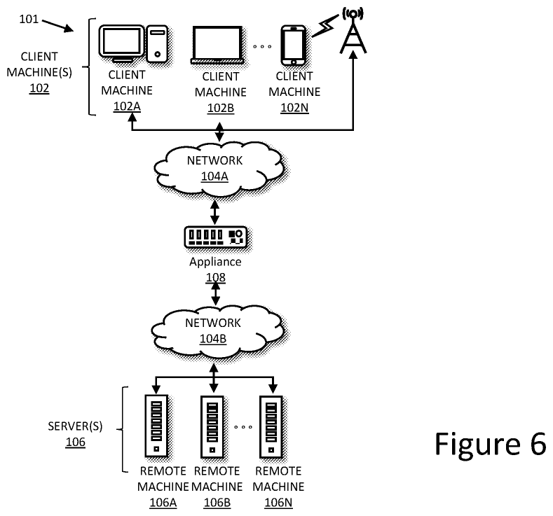

It is understood that the described systems and platforms can be implemented using any computing technique, e.g., as a stand-alone system, a distributed system, a cloud, a network environment, etc. Referring to FIG. 6, a non-limiting network environment 101 in which various aspects of the disclosure may be implemented includes one or more client machines 102A-102N, one or more remote machines 106A-106N, one or more networks 104A, 104B, and one or more appliances 108 installed within the computing environment 101. The client machines 102A-102N communicate with the remote machines 106A-106N via the networks 104A, 104B.

In some embodiments, the client machines 102A-102N communicate with the remote machines 106A-106N via an intermediary appliance 108. The illustrated appliance 108 is positioned between the networks 104A, 104B and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104A and/or 104B.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client machine 102 may have the capacity to function as both a client node seeking access to resources provided by a server 106 and as a server 106 providing access to hosted resources for other client machines 102A-102N. The networks 104A, 104B may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VOIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client machine 102.

In yet other embodiments, a server 106 may execute a virtual machine providing, to a user of a client machine 102, access to a computing environment. The client machine 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network; and a primary private network 104. Additional embodiments may include a network of mobile telephone networks that use various protocols to communicate among mobile devices. For short range communications within a wireless local-area network (WLAN), the protocols may include 802.11, Bluetooth, and Near Field Communication (NFC).

In certain embodiments, the network environment 101 may include space and satellite-based networks. Such embodiments may be particularly useful in remote regions, such as the Arctic, where space and satellite connectivity is critical for public and private mission-critical services and functions.

In further embodiments, the network environment 101 may include microservices, nano/molecular services and quantum computing services, including storage and processing. Such services are particularly useful for messy, incomplete and/or very large data sets, as well as for small, specialized computationally intensive tasks such as spatial data and image processing and cleaning, analysis, recognition, storage, reasoning and best practices case analyses.

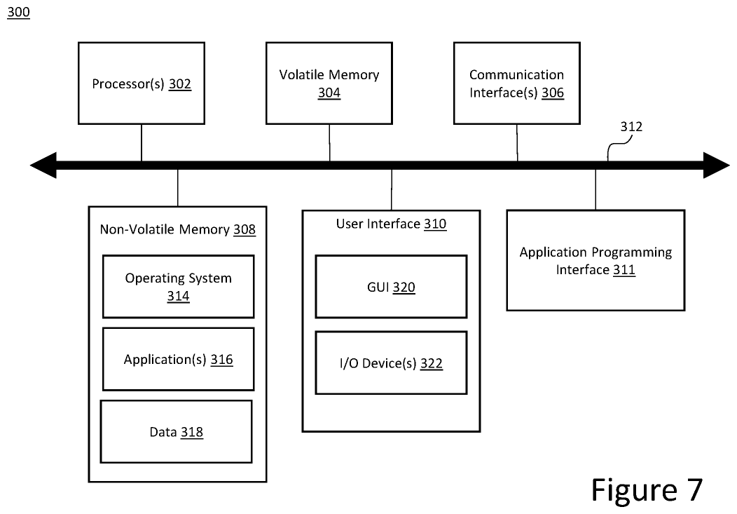

Elements of the described solution may be embodied in a computing system, such as that shown in FIG. 7 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, an application programming interface (API) 311 (which may, e.g., include middleware) and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 10 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A search and rescue (SAR) application platform, comprising:
a memory and a processor configured to provide SAR support services according to a process that includes:
receiving, at a mission support system, mission data from structured and unstructured data feeds including data from an unmanned aerial system (UAS);
outputting mission support information to a set of output nodes having disparate user interfaces (UIs), wherein at least one of the output nodes includes an augmented reality (AR) equipped device; and
receiving, at a large language model (LLM), queries from the mission support system, and generating AI responses that augment the mission support information, wherein the LLM is trained with a model training system using structured and unstructured data sources involving SAR content.

2. The SAR application platform of claim 1, wherein the mission support information comprises UAS data and AI responses configured for display on the AR equipped device.

3. The SAR application platform of claim 1, wherein the mission support information comprises communication, command and control (CCC) data and AI generated data.

4. The SAR application platform of claim 1, wherein the mission support information comprises an initial SAR plan that includes AI generated data.

5. The SAR application platform of claim 1, wherein the mission support system includes:
an input processor that stores mission data in a data cache; and
an LLM query processor that analyzes mission data in the data cache and generates queries for the LLM.

6. The SAR application platform of claim 5, wherein the AI responses from the LLM are analyzed by an LLM response processor and formatted for the disparate UIs.

7. The SAR application platform of claim 1, wherein the SAR content used to train the LLM comprises historical mission data.

8. The SAR application platform of claim 1, wherein the structured SAR content used to train the LLM comprises environment data, communication data, inventory data and logistic data.

9. The SAR application platform of claim 1, wherein the unstructured SAR content used to train the LLM comprises geological data, scientific data, sensor data, audio data, haptic data and social media data.

10. The SAR application platform of claim 1, wherein the disparate UIs include a smartphone UI, a laptop UI, and an AR equipped device UI.

11. The SAR application platform of claim 10, wherein the mission support information being output to the disparate UIs adheres to Universal Design (UD) principles.

12. The SAR application platform of claim 1, wherein the mission support system is implemented using a uniform emergency and disaster response (EDR) application development infrastructure, wherein the EDR application development infrastructure comprises:
a set of middleware services, including application programming interfaces (APIs) and scripts; and
a set of data management services accessed via the middleware services that provide access to EDR data sources, and provide data integration among UAS devices, AR devices and LLM resources.

13. The SAR application platform of claim 12, wherein the middleware services further include software modules and application templates.

14. The SAR application platform of claim 12, wherein the data management services further comprise data security protocols.

15. A method for providing search and rescue (SAR) support services, comprising:
receiving, at a mission support system, mission data from structured and unstructured data feeds including data from an unmanned aerial system (UAS);
outputting mission support information to a set of output nodes having disparate user interfaces (UIs), wherein at least one of the output nodes includes an augmented reality (AR) equipped device; and
receiving, at a generative artificial intelligence (AI) model, queries from the mission support system, and generating AI responses that augment the mission support information, wherein the generative AI model is trained using structured and unstructured data sources involving SAR content.

16. The method of claim 15, wherein the mission support information comprises UAS data and AI responses configured for display on the AR equipped device.

17. The method of claim 15, wherein the mission support information comprises an initial SAR plan that includes AI generated data.

18. The method of claim 15, wherein the SAR content used to train the generative AI model comprises historical mission data, environment data, communication data, inventory data and logistic data.

19. An emergency and disaster response (EDR) application platform, comprising:
a memory and a processor configured to provide EDR support services according to a process that includes:
receiving, at a mission support system, mission data from structured and unstructured data feeds including data from an unmanned aerial system (UAS);
outputting mission support information to a set of output nodes having disparate user interfaces (UIs), wherein at least one of the output nodes includes an augmented reality (AR) equipped device; and
receiving, at a large language model (LLM), queries from the mission support system, and generating AI responses that augment the mission support information, wherein the LLM is trained with a model training system using structured and unstructured data sources involving EDR content.

20. The EDR application platform is selected from a group consisting of: structural integrity assessment, search and rescue, emergency supply delivery, mapping and surveillance, and post disaster relief.
